(19) United States
(12) Patent Application Publication
(10) Pub. No.: US 2026/0008053 A1
(43) Pub. Date: Jan. 8, 2026

(54) MICROFLUIDIC TRANSFER SUBSTRATE, MICROFLUIDIC TRANSFER DEVICE, AND MICROFLUIDIC TRANSFER APPARATUS

(71) Applicant: HKC CORPORATION LIMITED, SHENZHEN (CN)

(72) Inventors: Zeyao LI, SHENZHEN (CN); Pei XU, SHENZHEN (CN)

(73) Assignee: HKC CORPORATION LIMITED, SHENZHEN (CN)

(21) Appl. No.: 19/244,231

(22) Filed: Jun. 20, 2025

(30) Foreign Application Priority Data
Jul. 2, 2024 (CN) 202410876333.4

(51) Int. Cl. B01L 3/00

(52) U.S. Cl. CPC B01L 3/50273; B01L 3/502707; B01L 2300/0645; B01L 2300/0654; B01L 2400/0415

(57) ABSTRACT

A microfluidic transfer substrate includes a plurality of pixel groups, and each of the plurality of pixel group consists of three first pixel units. One first pixel unit of each pixel group is configured to serve as a first microfluidic pixel and a surface of the first microfluidic pixel defines an assembly groove, and the other two first pixel units are configured to serve as second microfluidic pixels and a surface of each of the second microfluidic pixels is free of the assembly groove. The first pixel units of the plurality of pixel groups are in a hexagonal close-packed distribution, and lines connecting centers of the three first pixel units of each pixel group forms an equilateral triangle. A microfluidic transfer device and a microfluidic transfer apparatus are further provided.

### CROSS-REFERENCE TO RELATED APPLICATIONS

The present application claims priority to Chinese Patent Application No. 202410876333.4, entitled “MICROFLUIDIC TRANSFER SUBSTRATE, MICROFLUIDIC TRANSFER DEVICE, AND MICROFLUIDIC TRANSFER APPARATUS”, filed on Jul. 2, 2024, which is herein incorporated by reference in its entirety.

### TECHNICAL FIELD

The present disclosure relates to the technical field of display, and in particular to a microfluidic transfer substrate, a microfluidic transfer device, and a microfluidic transfer apparatus.

### BACKGROUND

With the advancement of light-emitting diode (LED) technology, micro-LED display technology is emerging as a revolutionary next-generation technology. The micro-LED is a display technology that miniaturizes and matrixes traditional LED structures, and achieves address control and individual driving of each pixel point through a driving backplane. Due to its superior performance in brightness, lifespan, contrast, response time, and other indicators compared to a liquid crystal display (LCD) and an organic light-emitting diode display (OLED), the micro-LED has been regarded by many manufacturers as the next-generation display technology, and the manufacturers have begun to actively layout the micro-LED.

However, a core technical challenge in the industrialization of the micro-LED is the mass transfer technology of micro-LED components. In related art, in a case where the micro-LED components are transferred to the driving backplane, there is a problem of low pixel density.

### SUMMARY OF THE DISCLOSURE

A technical solution in the present disclosure is to provide a microfluidic transfer substrate. The microfluidic transfer substrate includes a plurality of pixel groups, and each of the plurality of pixel group consists of three first pixel units. One first pixel unit of each pixel group is configured to serve as a first microfluidic pixel and a surface of the first microfluidic pixel defines an assembly groove, and the other two first pixel units are configured to serve as second microfluidic pixels and a surface of each of the second microfluidic pixels is free of the assembly groove. The first pixel units of the plurality of pixel groups are in a hexagonal close-packed distribution, and lines connecting centers of the three first pixel units of each pixel group forms an equilateral triangle.

In some embodiments, the plurality of pixel groups are arranged in a two-dimensional array, and the pixel groups in the same row consist of two rows of first pixel units.

In some embodiments, the first microfluidic pixels of the pixel groups in the same row belong to the first pixel units in the same row.

In some embodiments, the plurality of pixel groups are arranged in a two-dimensional array, and two adjacent rows of pixel groups consist of three rows of first pixel units; and a middle row of first pixel units in the three rows of first pixel units in the two adjacent rows of pixel groups are all the second microfluidic pixels.

In some embodiments, the plurality of pixel groups are arranged in a two-dimensional array, and two adjacent rows of pixel groups consist of three rows of first pixel units; and the first microfluidic pixels of two adjacent rows of pixel groups are all located in a middle row of three rows of first pixel units.

In some embodiments, two adjacent pixel groups share at least one second microfluidic pixel.

In some embodiments, the first pixel units of the plurality of pixel groups form a plurality of hexagonal close-packed units, and each hexagonal close-packed unit includes seven first pixel units; centers of six first pixel units are located at six vertices of a regular hexagon, respectively; a center of a seventh first pixel unit is located at a center of the regular hexagon; and each hexagonal close-packed unit includes three pixel groups, and the three pixel groups share the seventh first pixel unit.

In some embodiments, a shape of each first pixel unit is circular or regular hexagonal.

In some embodiments, the microfluidic transfer substrate further includes a plurality of gate lines and a plurality of data lines, each first pixel unit includes a thin film transistor, a first insulating layer, a planarization layer, a microfluidic electrode layer, a second insulating layer, and a hydrophobic layer. The number of the gate lines is equal to the number of rows of first pixel units, and gate electrodes of the thin film transistors of the first pixel units in the same row are electrically connected to the same gate line. The number of the data lines is equal to the number of columns of first pixel units, and source electrodes of the thin film transistors of the first pixel units in the same column are electrically connected to the same data line. A data line in a Nth column is short-circuited to a data line in a (N+1)th column, and N is defined as an odd number.

Another technical solution in the present disclosure is to provide a microfluidic transfer device. The microfluidic transfer device includes a microfluidic transfer substrate of any one of above embodiments and a microfluidic control circuit electrically connected to the microfluidic transfer substrate. The microfluidic control circuit is configured to control and drive a liquid droplet containing a light-emitting element to rotate around a center point of the equilateral triangle, so as to assemble the light-emitting element into the assembly groove.

Yet another technical solution in the present disclosure is to provide a microfluidic transfer apparatus. The microfluidic transfer apparatus includes a microfluidic transfer device of any one of above embodiments, a light source, a camera. The light source is disposed on one side of the microfluidic transfer substrate and electrically connected to the microfluidic control circuit. The camera is disposed on the other side of the microfluidic transfer substrate and electrically connected to the microfluidic control circuit. The microfluidic control circuit is further configured to control the light source to emit light and irradiate the microfluidic transfer substrate, control the camera to capture images of the microfluidic transfer substrate, and determine whether the light-emitting element is assembled in the assembly groove based on the images captured by the camera.

### BRIEF DESCRIPTION OF THE DRAWINGS

In order to more clearly illustrate the technical solutions in some embodiments of the present disclosure or in the related art, hereinafter, the accompanying drawings that are used in the description of some embodiments or the related art will be briefly described. Obviously, the accompanying drawings in the description below are merely the accompanying drawings in some embodiments of the present disclosure. For those of ordinary skill in the art, other accompanying drawings may be obtained based on these accompanying drawings without any creative efforts.

FIG. 1 is a structural block view of a microfluidic transfer device in the present disclosure.

FIG. 2 is a structural schematic view of a microfluidic transfer substrate in a first embodiment of the present disclosure.

FIG. 3 is a structural schematic view of a pixel group of the microfluidic transfer substrate of FIG. 2.

FIG. 4 is a structural schematic view of the pixel group of the microfluidic transfer substrate in an embodiment of the present disclosure.

FIG. 5 is a structural schematic view of the microfluidic transfer substrate in a second embodiment of the present disclosure.

FIG. 6 is a structural schematic view of the microfluidic transfer substrate in a third embodiment of the present disclosure.

FIG. 7 is a structural schematic view of the microfluidic transfer substrate in a fourth embodiment of the present disclosure.

FIG. 8 is a structural schematic view illustrating two adjacent pixel groups of the microfluidic transfer substrate in a fifth embodiment of the present disclosure.

FIG. 9 is a structural schematic view illustrating two adjacent pixel groups of the microfluidic transfer substrate in a sixth embodiment of the present disclosure.

FIG. 10 is a structural schematic view of a hexagonal close-packed unit of the microfluidic transfer substrate in a seventh embodiment of the present disclosure.

FIG. 11 is a cross-sectional structural schematic view of the microfluidic transfer substrate of FIG. 2.

FIG. 12 is a structural schematic view of the microfluidic transfer substrate of FIG. 2 after assembling a light-emitting element.

FIG. 13 is a cross-sectional structural schematic view of the microfluidic transfer substrate of FIG. 2 after assembling the light-emitting element.

FIG. 14 is a distribution schematic view illustrating gate lines, data lines, and first pixel units of the microfluidic transfer substrate in an embodiment of the present disclosure.

FIG. 15 is a structural block view of a microfluidic transfer apparatus in the present disclosure.

FIG. 16 is a structural schematic view illustrating transfer of the light-emitting elements from the microfluidic transfer substrate to the driving backplane in the present disclosure.

### DETAILED DESCRIPTION

The technical solutions in some embodiments of the present disclosure may be clearly and completely described in conjunction with accompanying drawings in some embodiments of the present disclosure. Obviously, the described embodiments are only a part of the embodiments of the present disclosure, and not all embodiments. Based on the embodiments in the present disclosure, all other embodiments obtained by those of ordinary skill in the art without creative effort are within the scope of the present disclosure.

The terms “first”, “second”, and “third” in the present disclosure are only configured to describe and cannot be understood as indicating or implying relative importance or implicitly indicating the quantity of technical features indicated. Therefore, features that are defined as “first”, “second”, and “third” may explicitly or implicitly include at least one of these features. In the description of the present disclosure, “multiple” means at least two, such as two, three, etc., unless otherwise expressly and specifically qualified. In addition, the terms “including”, “comprising”, and “having”, as well as any variations of the terms “including”, “comprising”, and “having”, are intended to cover non-exclusive inclusions. For example, a process, method, system, product, or apparatus that includes a series of operations or units is not limited to the listed operations or units, but optionally includes operations or units that are not listed, or optionally includes other operations or units that are inherent to these processes, methods, products, or apparatuses.

The reference to “embodiment” in the present disclosure means that, specific features, structures, or characteristics described in conjunction with some embodiments may be included in at least one embodiment of the present disclosure. The phrase appearing in various positions in the specification does not necessarily refer to the same embodiment, nor is it an independent or alternative embodiment that is mutually exclusive with other embodiments. Those of ordinary skill in the art explicitly and implicitly understand that the embodiments described in the present disclosure can be combined with other embodiments.

The present disclosure mainly provides a microfluidic transfer substrate, a microfluidic transfer device, and a microfluidic transfer apparatus, so as to solve the problem of low pixel density in a case where light-emitting elements are transferred to a driving backplane in related art.

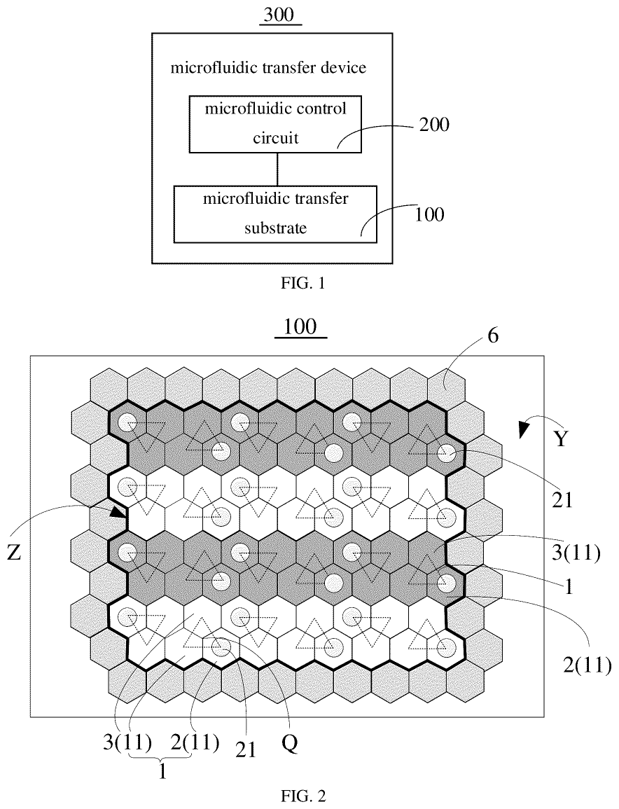

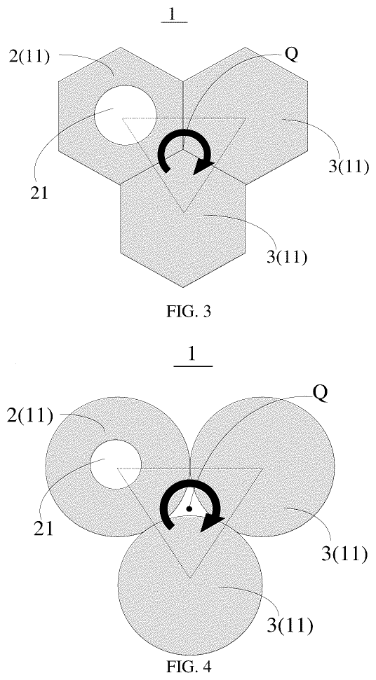

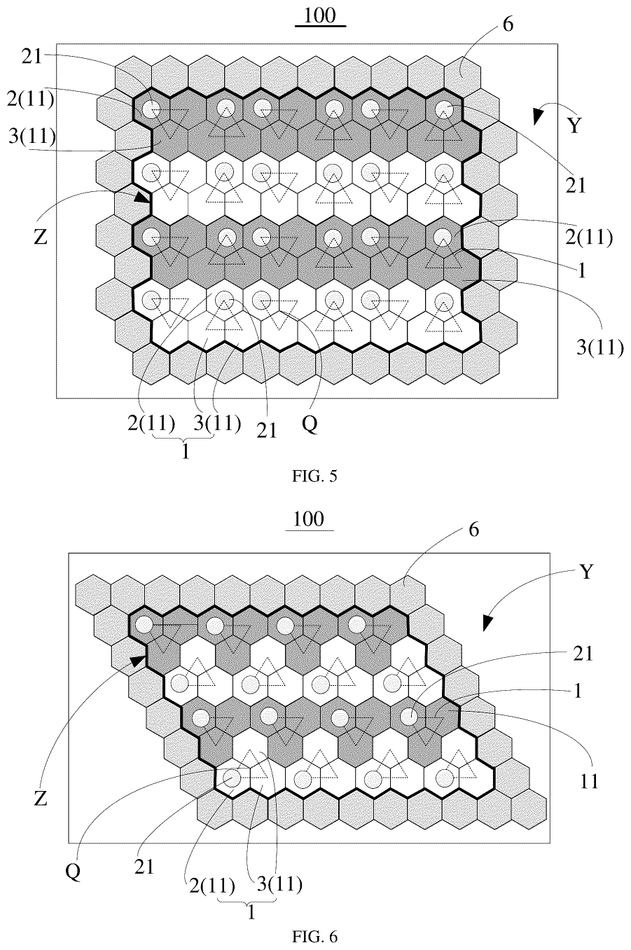

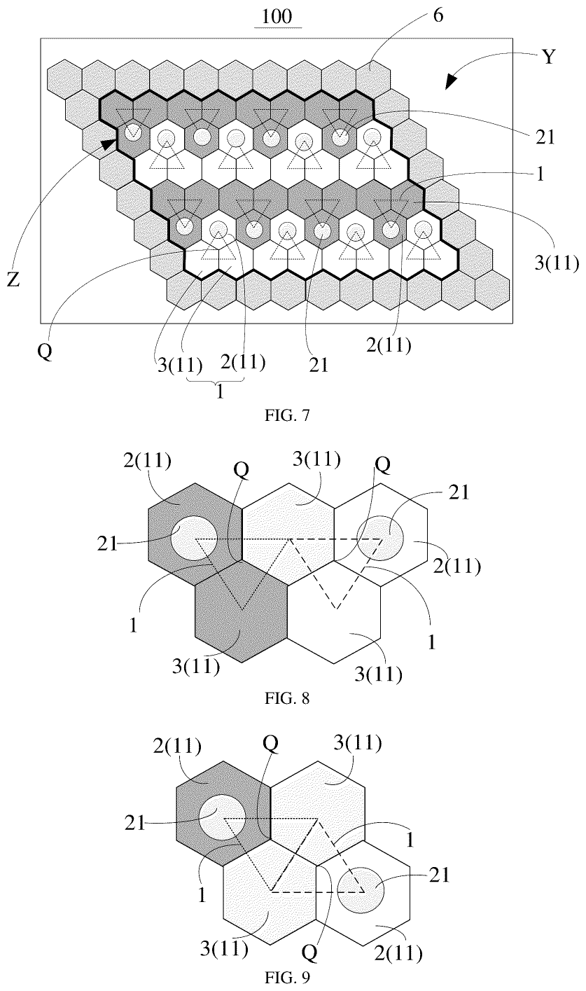

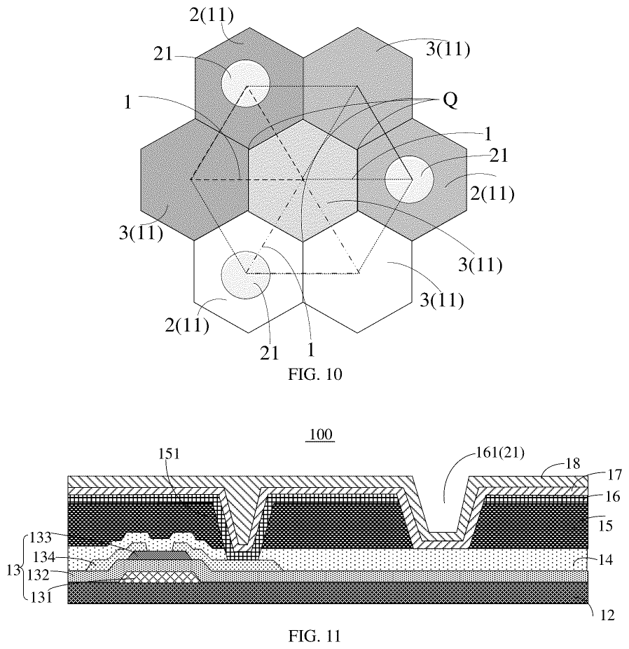

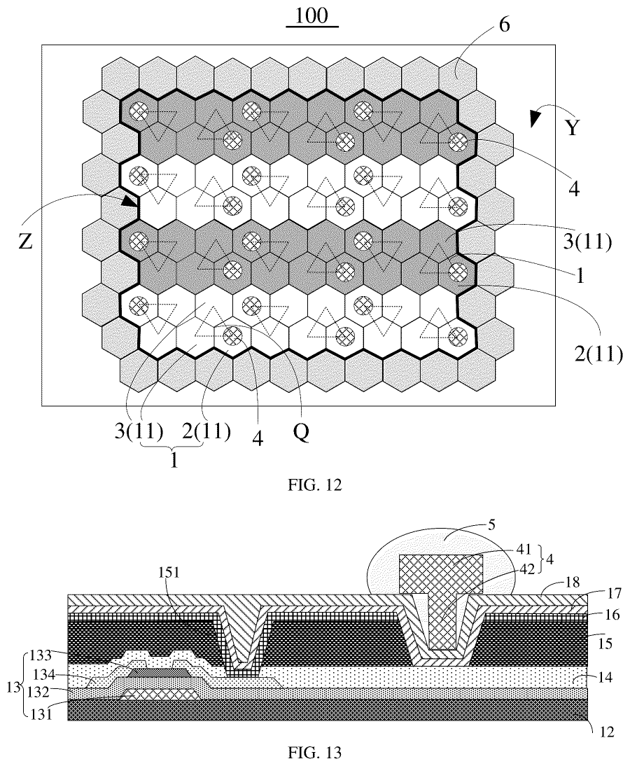

As illustrated in FIGS. 1 to 13, FIG. 1 is a structural block view of a microfluidic transfer device in the present disclosure. FIG. 2 is a structural schematic view of a microfluidic transfer substrate in a first embodiment of the present disclosure. FIG. 3 is a structural schematic view of a pixel group of the microfluidic transfer substrate of FIG. 2. FIG. 4 is a structural schematic view of the pixel group of the microfluidic transfer substrate in an embodiment of the present disclosure. FIG. 5 is a structural schematic view of the microfluidic transfer substrate in a second embodiment of the present disclosure. FIG. 6 is a structural schematic view of the microfluidic transfer substrate in a third embodiment of the present disclosure. FIG. 7 is a structural schematic view of the microfluidic transfer substrate in a fourth embodiment of the present disclosure. FIG. 8 is a structural schematic view illustrating two adjacent pixel groups of the microfluidic transfer substrate in a fifth embodiment of the present disclosure. FIG. 9 is a structural schematic view illustrating two adjacent pixel groups of the microfluidic transfer substrate in a sixth embodiment of the present disclosure. FIG. 10 is a structural schematic view of a hexagonal close-packed unit of the microfluidic transfer substrate in a seventh embodiment of the present disclosure. FIG. 11 is a cross-sectional structural schematic view of the microfluidic transfer substrate of FIG. 2. FIG. 12 is a structural schematic view of the microfluidic transfer substrate of FIG. 2 after assembling a light-emitting element. FIG. 13 is a cross-sectional structural schematic view of the microfluidic transfer substrate of FIG. 2 after assembling the light-emitting element.

As illustrated in FIG. 1, the present disclosure provides a microfluidic transfer device 300, and the microfluidic transfer device 300 may be configured for mass transfer of light-emitting elements 4. As illustrated in FIG. 1, the microfluidic transfer device 300 includes a microfluidic transfer substrate 100 and a microfluidic control circuit 200, the microfluidic control circuit 200 is electrically connected to the microfluidic transfer substrate 100.

In some embodiments, as illustrated in FIG. 2, the microfluidic transfer substrate 100 includes multiple pixel groups 1, each pixel group 1 is composed of three first pixel units 11. One first pixel unit 11 of each pixel group 1 serves as a first microfluidic pixel 2, and a surface of the first microfluidic pixel 2 defines an assembly groove 21. The other two first pixel units 11 serve as a second microfluidic pixel 3, and a surface of the second microfluidic pixel 3 does not define the assembly groove 21. The first pixel units 11 of multiple pixel groups 1 are arranged in a hexagonal close-packed distribution, and lines connecting a center of each of the three first pixel units 11 of each pixel group 1 form an equilateral triangle with a center point Q.

The microfluidic control circuit 200 is electrically connected to the microfluidic transfer substrate 100, which is configured to control and drive the liquid droplet 5 containing the light-emitting element 4 to rotate around the center point Q of the equilateral triangle, so as to assemble the light-emitting element 4 into the assembly groove 21.

By setting each pixel group 1 to include three first pixel units 11, one first pixel unit 11 of each pixel group 1 is the first microfluidic pixel 2, and the surface of the first microfluidic pixel 2 defines the assembly groove 21, it is easy to use the microfluidic transfer substrate 100 to assemble the light-emitting element 4 into the assembly groove 21 of the first microfluidic pixel 2, and then transfer the light-emitting element 4 assembled on the microfluidic transfer substrate 100 to the driving backplane 700, which is conducive to achieving mass transfer of the light-emitting element 4. The lines connecting the centers of the three first pixel units 11 form the equilateral triangle. Furthermore, the first pixel units 11 of the multiple pixel groups 1 are arranged in the hexagonal close-packed distribution, which may increase the distribution density of the pixel groups 1 and the first pixel units 11 of the microfluidic transfer substrate 100, and increase the pixel density of the first microfluidic pixels 2, thereby increasing the assembly density of the light-emitting elements 4, and improving the transfer efficiency and light-emitting efficiency of the light-emitting elements 4 transferred to the driving backplane 700. Moreover, by controlling and driving the liquid droplet 5 containing the light-emitting element 4 to rotate around the center point Q of the equilateral triangle through the microfluidic control circuit 200, it may be more conducive to improving the assembly efficiency and assembly accuracy of the light-emitting elements 4.

As illustrated in FIGS. 2 and 3, in some embodiments, a shape of the first pixel unit 11 is a regular hexagon, and each pixel group 1 includes three first pixel units 11. One first pixel unit 11 of each pixel group 1 is the first microfluidic pixel 2, and the first pixel units 11 of multiple pixel groups 1 are arranged in the hexagonal close-packed distribution. The lines connecting the centers of the three first pixel units 11 form the equilateral triangle. In the three first pixel units 11 of the same pixel group 1, every two adjacent first pixel units 11 have one coincident edge, that is, the shapes and the sizes of the three first pixel units 11 are the same.

As illustrated in FIG. 4, in some embodiments, the shape of the first pixel unit 11 is circular, and each pixel group 1 includes three first pixel units 11. One first pixel unit 11 of each pixel group 1 is the first microfluidic pixel 2. The first pixel units 11 of multiple pixel groups 1 are arranged in the hexagonal close-packed distribution, and every two adjacent first pixel units 11 in the same pixel group 1 are arranged in an externally tangent configuration. The lines connecting the centers of the three first pixel units 11 form the equilateral triangle, that is, the shapes and the sizes of the three first pixel units 11 are the same.

In some embodiments, the first pixel unit 11 of each pixel group 1 may also be set to any other shape, such as an equilateral triangle, and may be designed as needed, without limitation in the disclosure.

As illustrated in FIG. 2, in one embodiment, multiple pixel groups 1 of the microfluidic transfer substrate 100 are arranged in a two-dimensional array, and the pixel groups 1 in the same row are composed of two rows of first pixel units 11. In some embodiments, as illustrated in FIG. 2, the first pixel units 11 of two adjacent rows of pixel groups 1 are distributed in four rows. The pixel groups 1 in the same row are set to be composed of two rows of first pixel units 11, make it easy for the microfluidic control circuit 200 to control and drive the movement of the liquid droplet 5 containing the light-emitting element 4 between different pixel groups 1 and between the three first pixel units 11 in the pixel group 1, which is conducive to guiding the flow of the liquid droplet 5 containing the light-emitting element 4 and improving the assembly efficiency of the light-emitting elements 4.

In some embodiments, the first microfluidic pixels 2 of multiple pixel groups 1 may be freely distributed, that is, positions of the first microfluidic pixels 2 of multiple pixel groups 1 in the pixel groups 1 may be the same or different.

As illustrated in FIG. 2, in some embodiments, distribution positions of the first microfluidic pixels 2 of two adjacent pixel groups 1 in the same row are different, and the first microfluidic pixels 2 of two adjacent pixel groups 1 in the same row are located in the first pixel units 11 of different rows. In some embodiments, the first microfluidic pixel 2 of a first pixel group 1 in a first row of pixel groups 1 is located in a first pixel unit 11 of the first row, and the first microfluidic pixel 2 of a second pixel group 1 in the first row of pixel groups 1 is located in the first pixel unit 11 of the second row.

As illustrated in FIG. 5, in one embodiment, multiple pixel groups 1 of the microfluidic transfer substrate 100 are arranged in the two-dimensional array. The pixel groups 1 in the same row are composed of two rows of first pixel units 11. In some embodiments, as illustrated in FIG. 5, the first pixel units 11 of two adjacent rows of pixel groups 1 are distributed in four rows. As illustrated in FIG. 5, in this embodiment, the first microfluidic pixel 2 of the pixel group 1 in the same row is located in the first pixel unit 11 in the same row. That is, one row of the two adjacent rows of the first pixel unit 11 has the first microfluidic pixel 2, and the other row is the second microfluidic pixel 3. The first microfluidic pixel 2 of the pixel group 1 in the same row is located in the first pixel unit 11 of the same row, which may enable the microfluidic control circuit 200 to control and drive the liquid droplet 5 containing the light-emitting element 4 into the pixel group 1 from the row where the first pixel unit 11 that does not include the first microfluidic pixel 2 is located. This facilitates the movement of the liquid droplet 5 containing the light-emitting element 4, and prevents interference in the movement of the liquid droplets 5 containing the light-emitting element 4 in multiple pixel groups 1.

As illustrated in FIG. 5, in some embodiments, all the first microfluidic pixels 2 of the first row of pixel groups 1 are located in the first pixel unit 11 of the first row, and the second row of first pixel units 11 of the first row of pixel groups 1 are the second microfluidic pixels 3. The first microfluidic pixels 2 of all pixel groups 1 in the microfluidic transfer substrate 100 are located in the first pixel unit 11 in odd rows, and the first pixel units 11 in even rows are the second microfluidic pixels 3. In some embodiments, the first microfluidic pixels 2 may also be entirely located in the first pixel units 11 in the even rows, and the first pixel units 11 in the odd rows are all the second microfluidic pixels 3. Alternatively, the first microfluidic pixels 2 of two adjacent rows of pixel groups 1 may also be located in the first pixel units 11 of different rows. In some embodiments, the first microfluidic pixels 2 of the first row of pixel groups 1 are located in the first pixel units 11 of its internal first row, and the first microfluidic pixels 2 of the second row of pixel groups 1 are located in the first pixel units 11 of its internal second row, which may be designed as needed.

As illustrated in FIG. 6, in some embodiments, multiple pixel groups 1 are arranged in the two-dimensional array, and two adjacent rows of pixel groups 1 are composed of three rows of first pixel units 11. In some embodiments, a middle row of first pixel units 11 in the three rows of first pixel units 11 of two adjacent rows of pixel groups 1 are all the second microfluidic pixels 3. That is, the middle row of first pixel units 11 in the three rows of first pixel units 11 of two adjacent rows of pixel groups 1 do not define the assembly grooves 21.

Two adjacent rows of pixel groups 1 are composed of three rows of first pixel units 11, which may effectively increase the pixel density of the first microfluidic pixels 2 of the microfluidic transfer substrate 100, thereby increasing the assembly density of the light-emitting elements 4 assembled into the assembly grooves 21 of the first microfluidic pixels 2, and improving the transfer amount and the transfer efficiency of the light-emitting elements 4 transferred to the driving backplane 700, making it easier to achieve mass transfer of the light-emitting elements 4. Furthermore, the middle row of first pixel units 11 in the three rows of first pixel units 11 of two adjacent rows of pixel groups 1 are all the second microfluidic pixels 3, and the middle row of first pixel units 11 does not define the assembly grooves 21, which makes it easier for the microfluidic control circuit 200 to control and drive the liquid droplet 5 containing the light-emitting element 4 into the pixel group 1 from the row (i.e., the middle row) where the first pixel unit 11 that does not include the first microfluidic pixel 2 is located. This facilitates the movement of the liquid droplet 5 containing the light-emitting element 4, and prevents interference in the movement of the liquid droplets 5 containing the light-emitting elements 4 in multiple pixel groups 1, thereby improving the assembly efficiency.

In some embodiments, the distribution positions of the first microfluidic pixels 2 of multiple pixel groups 1 in the same row of pixel groups 1 are the same, as illustrated in FIG. 6. Two of the three first pixel units 11 of each pixel group 1 in the first row of pixel groups 1 are located in the first row of first pixel units 11, and the other first pixel unit 11 is located in the second row of first pixel units 11. The first microfluidic pixel 2 of each pixel group 1 in the first row of pixel groups 1 is located in the first row of first pixel units 11. In some embodiments, the first microfluidic pixel 2 of each pixel group 1 in the same row of pixel groups 1 may be located in the first pixel unit 11 in the same row but at different positions, or in the first pixel unit 11 in different rows, which may be designed as needed.

As illustrated in FIG. 7, in some embodiments, multiple pixel groups 1 are arranged in the two-dimensional array, and two adjacent rows of pixel groups 1 are composed of three rows of first pixel units 11. In some embodiments, the first microfluidic pixels 2 of two adjacent rows of pixel groups 1 are located in the middle row of the three rows of first pixel units 11, and the other two rows of first pixel units 11 are all the second microfluidic pixels 3.

Two adjacent rows of pixel groups 1 are composed of three rows of first pixel units 11, which may increase the distribution density of the first microfluidic pixels 2. The first microfluidic pixels 2 of two adjacent rows of pixel groups 1 are all located in the middle row of the three rows of first pixel units 11, so that the other two rows of first pixel units 11 do not define the assembly grooves 21, which makes it easier for the microfluidic control circuit 200 to control and drive the liquid droplet 5 containing the light-emitting element 4 into the pixel group 1 from the row where the first pixel unit 11 that does not include the first microfluidic pixel 2 is located. This facilitates the movement of the liquid droplet 5 containing the light-emitting element 4, and prevents interference in the movement of the liquid droplets 5 containing the light-emitting elements 4 in multiple pixel groups 1, thereby improving the assembly efficiency.

As illustrated in FIG. 7, in some embodiments, two adjacent rows of pixel groups 1 are composed of three rows of first pixel units 11, and all the first pixel units 11 in the middle row of the three rows of first pixel units 11 are the first microfluidic pixels 2, which may further increase the distribution density of the first microfluidic pixels 2. In some embodiments, the first microfluidic pixels 2 may also be located at other positions and may be designed as needed.

As illustrated in FIGS. 8 to 10, in some embodiments, the microfluidic transfer substrate 100 includes multiple pixel groups 1, each pixel group 1 are composed of three first pixel units 11, and two adjacent pixel groups 1 share at least one second microfluidic pixel 3. By sharing at least one second microfluidic pixel 3 between two adjacent pixel groups 1, the pixel density of the first microfluidic pixels 2 of the pixel groups 1 of the microfluidic transfer substrate 100 may be increased, which is conducive to increasing the assembly density of the light-emitting elements 4 and improving the transfer efficiency and light-emitting efficiency of the light-emitting elements 4 transferred to the driving backplane 700.

As illustrated in FIG. 8, in one embodiment, each pixel group 1 is composed of three first pixel units 11. One first pixel unit 11 of each pixel group 1 is the first microfluidic pixel 2, and the other two first pixel units 11 are the second microfluidic pixels 3. The first pixel unit 11 is the regular hexagon, and the lines connecting the centers of the three first pixel units 11 of each pixel group 1 form the equilateral triangle. Two adjacent pixel groups 1 share one second microfluidic pixel 3. As illustrated in FIG. 8, the first pixel units 11 of two adjacent pixel groups 1 form two equilateral triangles, and a vertex of one of the two equilateral triangles coincides with a vertex of the other of the two equilateral triangles.

As illustrated in FIG. 8, in some embodiments, the first microfluidic pixels 2 of two adjacent pixel groups 1 in the same row of pixel groups 1 are located in the first pixel units 11 of the same row, which makes it easier for the microfluidic control circuit 200 to control and drive the movement of the liquid droplet 5 containing light-emitting element 4, thereby facilitating assembly. In some embodiments, the first microfluidic pixels 2 of two adjacent pixel groups 1 in the same row of pixel groups 1 may also be located in the first pixel units 11 of different rows.

As illustrated in FIG. 9, in some embodiments, each pixel group 1 is composed of three first pixel units 11. One first pixel unit 11 of each pixel group 1 is the first microfluidic pixel 2, and the other two first pixel units 11 are the second microfluidic pixels 3. The first pixel unit 11 is the regular hexagon, and the lines connecting the centers of the three first pixel units 11 of each pixel group l form the equilateral triangle. Two adjacent pixel groups 1 share two second microfluidic pixels 3, and the first microfluidic pixels 2 of two adjacent pixel groups 1 in the same row are located in the first pixel units 11 of different rows. The two adjacent pixel groups 1 together include four first pixel units 11.

As illustrated in FIG. 9, the first pixel units 11 of two adjacent pixel groups 1 form two equilateral triangles, two vertices of one equilateral triangle coincide with two vertices of the other equilateral triangle. That is, one side of one equilateral triangle coincides with one side of the other equilateral triangle, which may further increase the pixel density of the first microfluidic pixels 2 of the microfluidic transfer substrate 100. In some embodiments, the first pixel unit 11 may also have other shapes such as a circle, and the first pixel units 11 may not be distributed in the array, which may be designed as needed.

As illustrated in FIG. 10, in some embodiments, the microfluidic transfer substrate 100 includes multiple pixel groups 1, and each pixel group 1 is composed of three first pixel units 11. The first pixel units 11 of the multiple pixel groups 1 form multiple hexagonal close-packed units, and each hexagonal close-packed unit includes seven first pixel units 11. The centers of the six first pixel units 11 are located at the six vertices of the regular hexagon, respectively. A center of a seventh first pixel unit 11 is located at the center of the regular hexagon. Each hexagonal close-packed unit includes three pixel groups 1, and the three pixel groups 1 share the seventh first pixel unit 11. That is, every three pixel groups 1 share one first pixel unit 11, and this first pixel unit 11 is the second microfluidic pixel 3.

The first pixel units 11 of multiple pixel groups 1 of the microfluidic transfer substrate 100 form multiple hexagonal close-packed units, every seven first pixel units 11 form three pixel groups 1, and every three pixel groups 1 share one first pixel unit 11. Therefore, the pixel density of the first microfluidic pixels 2 of the microfluidic control transfer substrate 100 may be further increased, which is conducive to increasing the assembly density of the light-emitting elements 4 and improving the transfer efficiency and the light-emitting efficiency of the light-emitting elements 4 transferred to the driving backplane 700.

As illustrated in FIG. 10, in some embodiments, the shape of the first pixel unit 11 is the regular hexagon. In some implementations, the first pixel unit 11 may also be circular, two adjacent first pixel units 11 are arranged in the externally tangent configuration. In some embodiments, the first pixel unit 11 may also have other shapes such as a regular octagon, and the first pixel units 11 of multiple pixel groups 1 may also form multiple octagonal close-packed units, which may be designed as needed.

As illustrated in FIG. 2, in some embodiments, the microfluidic transfer substrate 100 has a transfer zone Z and a liquid droplet generation zone Y surrounding the transfer zone Z. The multiple pixel groups 1 are disposed in the transfer zone Z, and the liquid droplet generation zone Y is configured to generate and transport the liquid droplet 5 containing light-emitting element 4 to the transfer zone Z. In some embodiments, the microfluidic control circuit 200 controls and drives the liquid droplet 5 containing the light-emitting element 4 from a position corresponding to the first pixel unit 11 without the first microfluidic pixel 2 into the pixel group 1 in the transfer zone Z, thereby improving the transport efficiency of the liquid droplet 5 and improving the assembly efficiency of the light-emitting element 4.

In some embodiments, the microfluidic transfer substrate 100 may not have the liquid droplet generation zone Y, that is, the microfluidic transfer substrate 100 may only have the transfer zone Z. The liquid droplet 5 containing light-emitting element 4 may be directly generated and transported to the zone where different pixel groups 1 are located in the transfer zone Z by disposing other structural components.

In some embodiments, multiple liquid droplets 5 containing light-emitting elements 4 may be uniformly generated by mixing a solution (not illustrated in figures) and the light-emitting elements 4 in the liquid droplet generation zone Y, and then the liquid droplets 5 containing the light-emitting elements 4 may be transported from the liquid droplet generation zone Y to the pixel groups 1 in the transfer zone Z.

In some embodiments, a specific structural component (not illustrated in figures) may be disposed to directly generate the liquid droplet 5 containing the light-emitting element 4 and directly transport the liquid droplet 5 containing light-emitting element 4 to each pixel group 1. That is, the liquid droplet generation zone Y may be omitted, and the liquid droplet 5 containing light-emitting element 4 may be directly generated and transported by the structural component. In some embodiments, the structural component may be a print head, and the print head may be located above the microfluidic transfer substrate 100, and may move between regions corresponding to different pixel groups 1. The liquid droplet 5 containing light-emitting element 4 may be directly dropped onto regions of the microfluidic transfer substrate 100 where different pixel groups 11 are located, so that each pixel group 1 contains one liquid droplet 5 containing the light-emitting element 4, which facilitates the assembly of the light-emitting elements 4, thereby facilitating the mass transfer of the light-emitting elements 4.

In some embodiments, the liquid droplet generation zone Y has multiple second pixel units 6, and all first pixel units 11 of the transfer zone Z and all second pixel units 6 of the liquid droplet generation zone Y are arranged in the hexagonal close-packed distribution. The multiple second pixel units 6 are disposed in the liquid droplet generation zone Y, and the second pixel units 6 and all first pixel units 11 of the transfer zone Z are arranged in the hexagonal close-packed distribution. Therefore, in a case where the liquid droplet 5 containing the light-emitting element 4 generated in the liquid droplet generation zone Y is transported to the pixel group 1 in the transfer zone Z, the second pixel unit 6 may be used as a transport channel for the liquid droplet 5, which is more conducive to driving the liquid droplet 5 containing the light-emitting element 4 to the position of the pixel group 1, and shortening a transport path of the liquid droplet 5, improving the transport efficiency of the liquid droplet 5, thereby improving the assembly efficiency of the light-emitting element 4.

In some embodiments, as illustrated in FIG. 2, both the first pixel unit 11 and the second pixel unit 6 are the regular hexagons. In some embodiments, both the first pixel unit 11 and the second pixel unit 6 may be set to be circular or the like, as long as all the first pixel units 11 in the transfer zone Z and all the second pixel units 6 in the liquid droplet generation zone Y are arranged in the hexagonal close-packed distribution together.

In some embodiments, the liquid droplet generation zone Y may not have the second pixel unit 6, the liquid droplet generation zone Y may be set only around the transfer zone Z, and the liquid droplet 5 containing the light-emitting element 4 is only generated in the liquid droplet generation zone Y. The liquid droplets 5 containing the light-emitting elements 4 generated in the liquid droplet generation zone Y may move in any direction or trajectory in the liquid droplet generation zone Y, as long as they may be transported from the liquid droplet generation zone Y to the transfer zone Z. Alternatively, the liquid droplet generation zone Y may not be set around the transfer zone Z, and may be set at any position in the transfer zone Z. In some embodiments, the liquid droplet generation zone Y may be set only on one or both sides of the transfer zone Z, as long as it can ensure that the liquid droplet generation zone Y may generate the liquid droplets 5 containing light-emitting elements 4 and may communicate with the transfer zone Z to transport the liquid droplets 5 containing light-emitting elements 4 to the transfer zone Z, which is not limited in the present disclosure.

In some embodiments, the microfluidic transfer substrate 100 only transmits light at the position of the assembly groove 21. In some embodiments, as illustrated in FIGS. 11 and 13, each of the first pixel unit 11 and the second pixel unit 6 includes a substrate 12, a thin film transistor (TFT) 13, a first insulating layer 14, a planarization layer 15, a microfluidic electrode layer 16, a second insulating layer 17, and a hydrophobic layer 18 arranged in sequence. The planarization layer 15 is an opaque layer, and the assembly groove 21 penetrates through the opaque layer.

In some embodiments, as illustrated in FIG. 11, the thin film transistor 13 is disposed on the substrate 12. The thin film transistor 13 includes a gate metal layer 131, a gate insulation layer 132, an active layer 133, and a source drain metal layer 134 stacked in sequence. The gate insulation layer 132 is disposed on a side of the gate metal layer 131 away from the substrate 12 and covers the gate metal layer 131 and the substrate 12. The active layer 133 is disposed at a position corresponding to the gate metal layer 131 and partially covers the gate insulation layer 132. The source drain metal layer 134 is disposed on a side of the active layer 133 away from the substrate 12 and covers a part of the active layer 133 and a part of the gate insulation layer 132. The source drain metal layer 134 includes a source electrode (not labeled in the figure) and a drain electrode (not labeled in the figure) arranged at intervals. A part of the active layer 133 is exposed at a position where the drain electrode and source electrode are spaced apart from each other. The first insulation layer 14 is located on a side of the source drain metal layer 134 away from the substrate 12 and covers the source drain metal layer 134, the active layer 133, and the gate insulation layer 132. The planarization layer 15, the microfluidic electrode layer 16, the second insulation layer 17, and the hydrophobic layer 18 are disposed on a surface of the first insulation layer 14 away from the substrate 12. The planarization layer 15 defines a via hole 151 spaced apart from the assembly groove 21, the via hole 151 sequentially penetrates through the planarization layer 15 and the first insulation layer 14 and expose a part of the source drain metal layer 134. The microfluidic electrode layer 16 covers the sidewalls of the via hole 151 and is in contact with the source drain metal layer 134.

In some embodiments, as illustrated in FIG. 11, the planarization layer 15 is a black material layer, and the black material layer defines through holes to expose a part of the first insulation layer 14, thereby forming the assembly groove 21.

In some embodiments, the microfluidic electrode layer 16 is a transparent conductive layer. The microfluidic electrode layer 16 may be a single continuous layer, or the microfluidic electrode layer 16 defines an opening 161 corresponding to the assembly groove 21. In some embodiments, the microfluidic electrode layer 16 may be a transparent conductive layer of indium tin oxide (ITO). As illustrated in FIG. 11, in some embodiments, the microfluidic electrode layer 16 defines the opening 161 at a position corresponding to the assembly groove 21, that is, the microfluidic electrode layer 16 is not disposed inside the assembly groove 21, and the opening 161 of the microfluidic electrode layer 16 directly exposes the assembly groove 21 and a part of the first insulation layer 14. In some embodiments, since the microfluidic electrode layer 16 is the transparent conductive layer, light may penetrate through the microfluidic electrode layer 16. Therefore, the microfluidic electrode layer 16 may not define the opening 161 at the position corresponding to the assembly groove 21, and the planarization layer 15 and the side surface and the bottom surface of the assembly groove 21 may be directly covered by the microfluidic electrode layer 16.

In some embodiments, the microfluidic electrode layer 16 may be the opaque layer, and the microfluidic electrode layer 16 defines the opening 161 at the position corresponding to the assembly groove 21. Due to the opaque nature of the microfluidic electrode layer 16, the opening 161 is defined at the position of the microfluidic electrode layer 16 corresponding to the assembly groove 21, so that the assembly groove 21 is exposed and the position of the assembly groove 21 may still transmit light.

That is, in some embodiments, the microfluidic electrode layer 16 is the transparent conductive layer, and the microfluidic electrode layer 16, the second insulation layer 17, and the hydrophobic layer 18 may all cover the bottom surface and the side surface of the assembly groove 21. In some embodiments, as illustrated in FIG. 11, the microfluidic electrode layer 16 may only be disposed on the surface of the black planarization layer 15 away from the substrate 12 and defines the opening 161 corresponding to the assembly groove 21, and the second insulation layer 17 and the hydrophobic layer 18 may all cover the bottom surface and the side surface of the assembly groove 21.

In the present embodiment, the microfluidic transfer substrate 100 only transmits light at the position of the assembly groove 21. In a case where the liquid droplet 5 containing the light-emitting element 4 is driven to assemble the light-emitting element 4 into the assembly groove 21 of the first microfluidic pixel 2, the assembly groove 21 is filled with the light-emitting element 4. In a case where the light irradiates the microfluidic transfer substrate 100, the light passing through the assembly groove 21 may be greatly reduced, and even the position of the assembly groove 21 may no longer transmit light. Therefore, the microfluidic transfer substrate 100 may be irradiated by a light source 400 or the like to detect or determine whether the light-emitting element 4 is assembled in the assembly groove 21, and accordingly the position of the first microfluidic pixel 2 that is not provided with the light-emitting element 4 may be screened out for subsequent operations, such as secondary assembly.

As illustrated in FIGS. 12 and 13, after transporting the liquid droplet 5 containing the light-emitting element 4 to the pixel group 1 in the transfer zone Z, and assembling the light-emitting element 4 into the assembly groove 21 of the first microfluidic pixel 2, the structure of the microfluidic transfer substrate 100 is illustrated in FIGS. 12 and 13.

As illustrated in FIG. 13, in some embodiments, the light-emitting element 4 is a light-emitting diode (LED), the light-emitting diode includes a body part 41 and a protruding part 42 protruding from the body part 41. A width of the protruding part 42 is less than that of the assembly groove 21, and a width of the body part 41 is greater than that of the assembly groove 21. After assembling the light-emitting element 4 into the assembly groove 21, the protruding part 42 is inserted into the assembly groove 21, and the body part 41 protrudes from the assembly groove 21. The width of the protruding part 42 of the light-emitting element 4 is set to be less than that of the assembly groove 21, and the width of the body part 41 is set to be greater than that of the assembly groove 21. Therefore, the protruding part 42 may be matched with the assembly groove 21, and the assembly of the light-emitting element 4 in the assembly groove 21 may be achieved by inserting the protruding part 42 into the assembly groove 21, which is more conducive to improving the assembly efficiency. After assembling the protruding part 42 into the assembly groove 21, the light-emitting element 4 is not easily detached from the assembly groove 21, which is conducive to improving the assembly yield.

In some embodiments, the light-emitting element 4 may not include the protruding part 42, but only include the body part 41. The body part 41 of the light-emitting element 4 may be directly assembled into the assembly groove 21 of the first microfluidic pixel 2. Alternatively, the light-emitting element 4 may be a micro light-emitting diode, which may be designed according to needs.

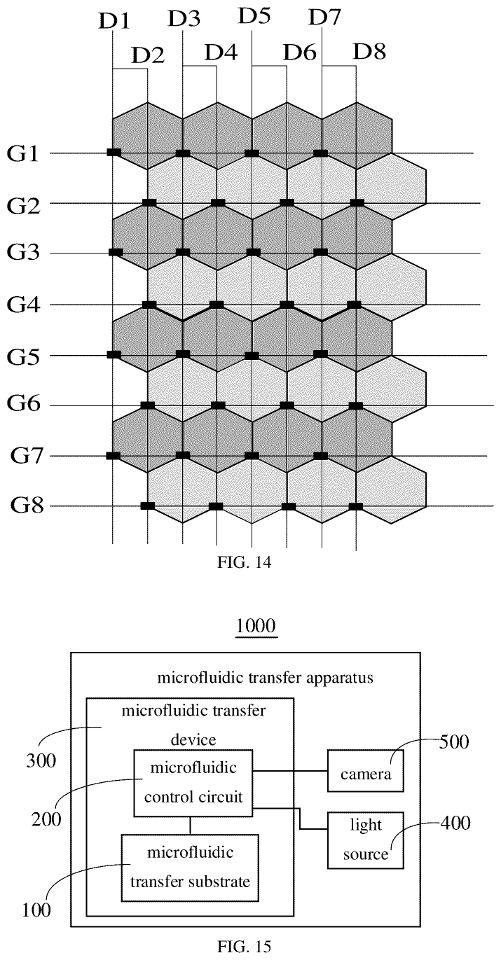

As illustrated in FIG. 14, FIG. 14 is a distribution schematic view illustrating gate lines, data lines, and first pixel units of the microfluidic transfer substrate in an embodiment of the present disclosure.

As illustrated in FIG. 14, the microfluidic transfer substrate 100 further includes multiple gate lines and multiple data lines. The number of gate lines is equal to the number of rows of the first pixel units 11. The gate electrodes of the thin film transistors 13 of the first pixel units 11 in the same row are electrically connected to the same gate line, that is, all first pixel units 11 in the same row are driven and controlled by the same gate line. The number of data lines is equal to the number of columns of the first pixel units 11. The source electrodes of the thin film transistors 13 of the first pixel units 11 in the same column are electrically connected to the same data line. The data line in the Nth column is short-circuited to the data line in the (N+1)th column, wherein N is defined as an odd number. That is, the first pixel units 11 in the odd column and the first pixel units 11 in the even column that are adjacent to the first pixel unit 11 in the odd column may be controlled by two short-circuited data lines, and the first pixel units 11 in the even column is located on the right of the first pixel units 11 in the odd column.

As illustrated in FIG. 14, in some embodiments, multiple first pixel units 11 are illustrated. The multiple first pixel units 11 are distributed in an eight-by-eight array, with rows labeled from top to bottom as a first row, a second row . . . an eighth row, and columns labeled from left to right as a first column, a second column . . . an eighth column. Each row of first pixel units 11 is electrically connected to the same gate line and controlled by the same gate line. In some embodiments, the first row of first pixel units 11 is electrically connected to a first gate line D1, the second row of first pixel units 11 is electrically connected to a second gate line D2, . . . and so on. The eighth row of first pixel units 11 is electrically connected to an eighth gate line D8. Each column of first pixel units 11 is electrically connected to the same data line and controlled by the same data line. In some embodiments, the first column of first pixel units 11 is electrically connected to a first data line G1, the second column of first pixel units 11 is electrically connected to a second data line G2, . . . and so on. The eighth column of first pixel units 11 is electrically connected to an eighth data line G8.

The data line in the Nth column is short-circuited to the data line in the (N+1)th column, wherein N is defined as the odd number. In some embodiments, the first data line G1 electrically connected to the first pixel units 11 in the first column is short-circuited to the second data line G2 electrically connected to the first pixel units 11 in the second column. The third data line G3 electrically connected to the first pixel units 11 in the third column is short-circuited to the fourth data line G4 electrically connected to the first pixel units 11 in the fourth column, and so on. The fifth data line G5 is short-circuited to the sixth data line G6, and the seventh data line G7 is short-circuited to the eighth data line G8. By electrically connecting two adjacent columns of first pixel units 11 to different data lines and short-circuiting the two data lines, it is possible to input the same data signal to two adjacent columns of first pixel units 11, so as to simultaneously control two adjacent columns of first pixel units 11, which is conducive to reducing the number of signal channels and simplifying the structure.

In the microfluidic transfer substrate 100 provided by the present disclosure, the first pixel units 11 of multiple pixel groups 1 are arranged in the hexagonal close-packed distribution, and the lines connecting the centers of the three first pixel units 11 of each pixel group 1 form the equilateral triangle, which may effectively increase the pixel density of the first microfluidic pixels 2 on the microfluidic transfer substrate 100, it is conducive to increasing the assembly density of the light-emitting elements 4, thereby improving the transfer efficiency and light-emitting efficiency of the light-emitting elements 4 transferred to the driving backplane 700.

As illustrated in FIG. 15, FIG. 15 is a structural block view of a microfluidic transfer apparatus in the present disclosure.

As illustrated in FIG. 15, the present disclosure further provides a microfluidic transfer apparatus 1000, which may be configured to achieve mass transfer of the light-emitting elements 4. In some embodiments, the microfluidic transfer apparatus 1000 includes the microfluidic transfer device 300, the light source 400, and a camera 500. The microfluidic transfer device 300 may be any one of the microfluidic transfer devices 300 in the above embodiments. The light source 400 is disposed on one side of the microfluidic transfer substrate 100 of the microfluidic transfer device 300 and electrically connected to the microfluidic control circuit 200 of the microfluidic transfer device 300. The camera 500 is disposed on the other side of the microfluidic transfer substrate 100 and electrically connected to the microfluidic control circuit 200. In some embodiments, the camera 500 is a high-resolution camera 500.

In some embodiments, the microfluidic control circuit 200 is further configured to control the light source 400 to emit light and irradiate the microfluidic transfer substrate 100, and control the camera 500 to capture images of the microfluidic transfer substrate 100, and determine whether the light-emitting element 4 is assembled in the assembly groove 21 based on the images captured by the camera 500.

In some embodiments, since the planarization layer 15 of the present disclosure is the opaque layer, in a case where the light-emitting element 4 is assembled in the assembly groove 21 of the first microfluidic pixel 2 of the microfluidic transfer substrate 100, the microfluidic control circuit 200 controls the light source 400 to emit light and irradiate the microfluidic transfer substrate 100. The light passing through the assembly groove 21 may be greatly reduced or even the position of the assembly groove 21 may no longer be transparent or transmit light. In a case where some assembly grooves 21 are not provided with the light-emitting elements 4, and the light source 400 emits light and irradiates the microfluidic transfer substrate 100, the light passing through the assembly groove 21 without the light-emitting element 4 is still sufficient. The microfluidic control circuit 200 controls the camera 500 to captured the images of the microfluidic transfer substrate 100. Based on these images, it may be clearly determined which first microfluidic pixels 2 of the multiple pixel groups 1 on the microfluidic transfer substrate 100 have not been assembled with the light-emitting element 4 into their assembly grooves 21, and which first microfluidic pixels 2 have already had the light-emitting devices 4 assembled into their assembly grooves 21. It may determine the assembly yield of the light-emitting elements 4 on the microfluidic transfer substrate 100, so that in a case where the assembly yield does not meet the standard, subsequent operations such as secondary assembly may be carried out on the first microfluidic pixel 2 that has not been assembled with the light-emitting element 4.

In some embodiments, the microfluidic control circuit 200 may control and drive the liquid droplet 5 containing the light-emitting element 4 to supplement the assembly of the light-emitting element 4 into the assembly groove 21 without the light-emitting element 4, so as to improve the assembly rate of the light-emitting elements 4 on the microfluidic transfer substrate 100, thereby improving the transfer efficiency and light-emitting efficiency of the light-emitting elements 4 transferred to the driving backplane 700.

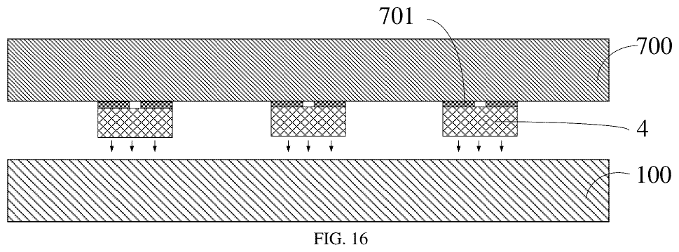

As illustrated in FIG. 16, FIG. 16 is a structural schematic view illustrating transfer of the light-emitting elements from the microfluidic transfer substrate to the driving backplane in the present disclosure.

As illustrated in FIG. 16, after the microfluidic control circuit 200 has driven and controlled the assembly of the light-emitting elements 4 into the assembly grooves 21 of the first microfluidic pixels 2 of the microfluidic transfer substrate 100, the microfluidic transfer substrate 100 with the assembled light-emitting elements 4 is attached to the driving backplane 700. In some embodiments, the microfluidic transfer substrate 100 and the driving backplane 700 are pressed together on the side with driving electrodes 701, so that the light-emitting elements 4 in the assembly grooves 21 of the microfluidic transfer substrate 100 are transferred to the driving backplane 700, completing the transfer of the light-emitting elements 4. After transferring the light-emitting elements 4 onto the driving backplane 700, the microfluidic transfer substrate 100 may be separated from the driving backplane 700 for easy reuse of the microfluidic transfer substrate 100.

Different from the related art, the effects of the present disclosure are as follows. The present disclosure provides a microfluidic transfer substrate, a microfluidic transfer device, and a microfluidic transfer apparatus. The microfluidic transfer substrate includes a plurality of pixel groups, and each of the plurality of pixel group consists of three first pixel units. One first pixel unit of each pixel group is configured to serve as a first microfluidic pixel and a surface of the first microfluidic pixel defines an assembly groove, and the other two first pixel units are configured to serve as a second microfluidic pixel and a surface of the second microfluidic pixel is free of the assembly groove. The first pixel units of the plurality of pixel groups are in a hexagonal close-packed distribution, and lines connecting centers of the three first pixel units of each pixel group forms an equilateral triangle. By the above settings, it may achieve mass transfer of the light-emitting elements and increase the pixel density of the microfluidic transfer substrate, solving the problem of low pixel density in a case where the light-emitting elements are transferred to the driving backplane in the related art, and thus improving the light-emitting efficiency of the light-emitting elements transferred to the driving backplane.

The above descriptions are only some embodiments of the present disclosure, and are not intended to limit the protection scope of the present disclosure. Any equivalent structure or equivalent flow transformation made by using the contents and the accompanying drawings of the present disclosure, or directly or indirectly applied to other related technical fields, is included in the protection scope of the present disclosure.

1. A microfluidic transfer substrate, comprising:
a plurality of pixel groups, wherein each of the plurality of pixel group consists of three first pixel units, one first pixel unit of each pixel group is configured to serve as a first microfluidic pixel and a surface of the first microfluidic pixel defines an assembly groove, and the other two first pixel units are configured to serve as second microfluidic pixels and a surface of each of the second microfluidic pixels is free of the assembly groove;
wherein the first pixel units of the plurality of pixel groups are in a hexagonal close-packed distribution, and lines connecting centers of the three first pixel units of each pixel group form an equilateral triangle.

2. The microfluidic transfer substrate according to claim 1, wherein
the plurality of pixel groups are arranged in a two-dimensional array, and the pixel groups in the same row consist of two rows of first pixel units.

3. The microfluidic transfer substrate according to claim 2, wherein
the first microfluidic pixels of the pixel groups in the same row belong to the first pixel units in the same row.

4. The microfluidic transfer substrate according to claim 1, wherein
the plurality of pixel groups are arranged in a two-dimensional array, and two adjacent rows of pixel groups consist of three rows of first pixel units; and
a middle row of first pixel units in the three rows of first pixel units in the two adjacent rows of pixel groups are all the second microfluidic pixels.

5. The microfluidic transfer substrate according to claim 1, wherein
the plurality of pixel groups are arranged in a two-dimensional array, and two adjacent rows of pixel groups consist of three rows of first pixel units; and
the first microfluidic pixels of two adjacent rows of pixel groups are all located in a middle row of three rows of first pixel units.

6. The microfluidic transfer substrate according to claim 1, wherein
two adjacent pixel groups share at least one second microfluidic pixel.

7. The microfluidic transfer substrate according to claim 6, wherein
the first pixel units of the plurality of pixel groups form a plurality of hexagonal close-packed units, and each hexagonal close-packed unit comprises seven first pixel units; centers of six first pixel units are located at six vertices of a regular hexagon, respectively; and a center of a seventh first pixel unit is located at a center of the regular hexagon; and
each hexagonal close-packed unit comprises three pixel groups, and the three pixel groups share the seventh first pixel unit.

8. The microfluidic transfer substrate according to claim 1, wherein
a shape of each first pixel unit is circular or regular hexagonal.

9. The microfluidic transfer substrate according to claim 1, wherein
the microfluidic transfer substrate further comprises a plurality of gate lines and a plurality of data lines, each first pixel unit comprises a thin film transistor, a first insulating layer, a planarization layer, a microfluidic electrode layer, a second insulating layer, and a hydrophobic layer;
the number of the gate lines is equal to the number of rows of first pixel units, and gate electrodes of the thin film transistors of the first pixel units in the same row are electrically connected to the same gate line; the number of the data lines is equal to the number of columns of first pixel units, and source electrodes of the thin film transistors of the first pixel units in the same column are electrically connected to the same data line; and a data line in a Nth column is short-circuited to a data line in a (N+1)th column, and N is defined as an odd number.

10. A microfluidic transfer device, comprising:
a microfluidic transfer substrate, comprising:
a plurality of pixel groups, wherein each of the plurality of pixel group consists of three first pixel units, one first pixel unit of each pixel group is configured to serve as a first microfluidic pixel and a surface of the first microfluidic pixel defines an assembly groove, and the other two first pixel units are configured to serve as second microfluidic pixels and a surface of each of the second microfluidic pixels is free of the assembly groove;
wherein the first pixel units of the plurality of pixel groups are in a hexagonal close-packed distribution, and lines connecting centers of the three first pixel units of each pixel group form an equilateral triangle; and
a microfluidic control circuit, electrically connected to the microfluidic transfer substrate, wherein the microfluidic control circuit is configured to control and drive a liquid droplet containing a light-emitting element to rotate around a center point of the equilateral triangle, so as to assemble the light-emitting element into the assembly groove.

11. The microfluidic transfer device according to claim 10, wherein
the plurality of pixel groups are arranged in a two-dimensional array, and the pixel groups in the same row consist of two rows of first pixel units.

12. The microfluidic transfer device according to claim 11, wherein
the first microfluidic pixels of the pixel groups in the same row belong to the first pixel units in the same row.

13. The microfluidic transfer device according to claim 10, wherein
the plurality of pixel groups are arranged in a two-dimensional array, and two adjacent rows of pixel groups consist of three rows of first pixel units; and
a middle row of first pixel units in the three rows of first pixel units in the two adjacent rows of pixel groups are all the second microfluidic pixels.

14. The microfluidic transfer device according to claim 10, wherein
the plurality of pixel groups are arranged in a two-dimensional array, and two adjacent rows of pixel groups consist of three rows of first pixel units; and
the first microfluidic pixels of two adjacent rows of pixel groups are all located in a middle row of three rows of first pixel units.

15. The microfluidic transfer device according to claim 10, wherein
two adjacent pixel groups share at least one second microfluidic pixel.

16. The microfluidic transfer device according to claim 15, wherein
the first pixel units of the plurality of pixel groups form a plurality of hexagonal close-packed units, and each hexagonal close-packed unit comprises seven first pixel units; centers of six first pixel units are located at six vertices of a regular hexagon, respectively; and a center of a seventh first pixel unit is located at a center of the regular hexagon; and
each hexagonal close-packed unit comprises three pixel groups, and the three pixel groups share the seventh first pixel unit.

17. The microfluidic transfer device according to claim 10, wherein
a shape of each first pixel unit is circular or regular hexagonal.

18. The microfluidic transfer device according to claim 10, wherein
the microfluidic transfer substrate further comprises a plurality of gate lines and a plurality of data lines, each first pixel unit comprises a thin film transistor, a first insulating layer, a planarization layer, a microfluidic electrode layer, a second insulating layer, and a hydrophobic layer;
the number of the gate lines is equal to the number of rows of first pixel units, and gate electrodes of the thin film transistors of the first pixel units in the same row are electrically connected to the same gate line; the number of the data lines is equal to the number of columns of first pixel units, and source electrodes of the thin film transistors of the first pixel units in the same column are electrically connected to the same data line; and a data line in a Nth column is short-circuited to a data line in a (N+1)th column, and N is defined as an odd number.

19. A microfluidic transfer apparatus, comprising:
a microfluidic transfer device, comprising:
a microfluidic transfer substrate, comprising:
a plurality of pixel groups, wherein each of the plurality of pixel group consists of three first pixel units, one first pixel unit of each pixel group is configured to serve as a first microfluidic pixel and a surface of the first microfluidic pixel defines an assembly groove, and the other two first pixel units are configured to serve as second microfluidic pixels and a surface of each of the second microfluidic pixels is free of the assembly groove;
wherein the first pixel units of the plurality of pixel groups are in a hexagonal close-packed distribution, and lines connecting centers of the three first pixel units of each pixel group form an equilateral triangle; and
a microfluidic control circuit, electrically connected to the microfluidic transfer substrate, wherein the microfluidic control circuit is configured to control and drive a liquid droplet containing a light-emitting element to rotate around a center point of the equilateral triangle, so as to assemble the light-emitting element into the assembly groove;
a light source, disposed on one side of the microfluidic transfer substrate and electrically connected to the microfluidic control circuit; and
a camera, disposed on the other side of the microfluidic transfer substrate and electrically connected to the microfluidic control circuit;
wherein the microfluidic control circuit is further configured to control the light source to emit light and irradiate the microfluidic transfer substrate, control the camera to capture images of the microfluidic transfer substrate, and determine whether the light-emitting element is assembled in the assembly groove based on the images captured by the camera.

20. The microfluidic transfer apparatus according to claim 19, wherein
the plurality of pixel groups are arranged in a two-dimensional array, and the pixel groups in the same row consist of two rows of first pixel units.
